(19) United States
(12) Patent Application Publication
(10) Pub. No.: US 2021/0331865 A1
(43) Pub. Date: Oct. 28, 2021

(54) CABLE DRIVEN STORAGE AND RETRIEVAL MACHINE FOR WAREHOUSES

(71) Applicant: Dematic GmbH, Heusenstamm (DE)

(72) Inventor: Jad Abou-Chakra, St Ives NSW (AU)

(21) Appl. No.: 17/264,533

(22) PCT Filed: Jul. 11, 2019
(86) PCT No.: PCT/EP2019/068725

§ 371 Date: Jan. 29, 2021

(30) Foreign Application Priority Data
Aug. 2, 2018 (AU) 2018211306

(51) Int. Cl. B65G 1/04; B25J 9/00; B66C 21/00

(52) U.S. Cl. CPC B65G 1/0421; B66C 2700/011; B66C 21/00; B25J 9/0078

(57) ABSTRACT

A warehouse with a cable driven transport vehicle for movement of items within the warehouse, where the cable driven storage and retrieval machine comprises a load handling platform that is suspended by cables, which are variable in length and tensioned by cable tensioning means, such that the load handling platform can access a given workspace of the warehouse, and where the cable tensioning means themselves are made to be moveable within the given workspace.

### CROSS REFERENCE TO RELATED APPLICATION

The present application claims the priority benefits of International Patent Application No. PCT/EP2019/068725, filed Jul. 11, 2019, and claims benefit of Australian patent application no. AU2018211306, filed on Aug. 2, 2018.

### BACKGROUND AND FIELD OF THE INVENTION

Cable driven robots that move in three dimensions are know from e.g. U.S. Pat. No. 7,753,642 B2. Such robots comprise a robotic platform, that is moved in three dimensions by cable attached to it. To do so the cables are shortened or lengthened by winches, such that the platform is moved in the desired direction.

US 2015/0217975 A1 describes the use of such robotic platforms for two-dimensional (vertical and horizontal) movement in warehouses as storage and retrieval machines for accessing shelves of a rack.

In these cable driven automatic storage and retrieval machines, a platform is attached by cables to static non moving motors. The motors pull on the cables and therefore cause the suspended vehicle to move, as described above.

These systems have a very low inertia compared to miniload cranes or classical ASRS, which position a vertically moveable platform on a rail mounted mast. However, unlike these standard ASRS machines, cable suspended systems have a limited workspace due to control challenges and due to needing proportionately bigger cable reels as the workspace grows. Cable sagging, cable strain and stretching etc. may also occur as cable length grows.

US 2005/0036859 A1 describes a storage and retrieval unit which comprises a supporting carriage which is movable along a rack aisle on at least one substantially horizontal supporting rail by means of a drive mounted at the top of the racking, wherein a vertically adjustable lifting platform is suspended from the supporting carriage. The lifting platform uses a stabilizing device comprising four tensioning ropes is provided. Two of these tensioning ropes are fastened to opposite sides of the lifting platform in each case. Each tensioning rope runs from the lifting platform to a rope drum. The rope drums are situated in pairs on the floor at the opposite ends of the rack aisle in a fixed manner. JP 2005-154090 A describes a similar system.

US 2004/00234364 A1 describes a similar storage and retrieval unit that in contrast to the one mentioned above which contains a stabilizing device which comprises at least one guide element extending substantially horizontally parallel to the translatory movement path of the lifting platform. This guide element is in constant engagement with the lifting platform in such a way that the position of this latter in the direction of the translatory movement is constantly defined.

### SUMMARY OF THE INVENTION

The present invention provides a cable driven transport vehicle for use in a warehouse for movement of items, including use of such a transport vehicle as a storage and retrieval machine for warehouses or for use in storage racks to access the shelves, which does not have limitations on workspace size.

In accordance with an embodiment of the invention, the cable driven storage and retrieval machine comprises at least four cable tensioning means which are moveable and individually operable in a synchronized fashion by a control to a) move the load handling platform in the given workspace along the face of a storage racking by controlled movement of the at least four cable tensioning means along the face of the storage racking within the given workspace along guide tracks; and/or b) operate the at least four cable tensioning means in a controlled fashion to move the load handling platform in the given workspace along the face of a storage racking by controlled variation in length and tension of the cables.

In other words, a novel cable driven storage and retrieval machine is provided that is designed to essentially operate in two modes. In the first mode only the cable tensioning means are moved in a mutually synchronized and controlled fashion in the given workspace, by which movement the load handling platform is also moved indirectly. In this mode the cable length and tension are not changed. In the second mode the cable length and tension are however changed by controlled operation of the cable tensioning means to move the load handling platform directly, wherein the cable tensioning means are stationary. It is also possible to overlay both methods, i.e. perform them in parallel.

In accordance with an aspect of the present invention, it has been recognized that if the cable tensioning means (winches, motors etc.) themselves are made to be moveable, it is possible to extend the working range of the cable driven transport vehicle without the cable span growing, i.e. being large and creating problems as described. In other words, this novel system proposes that the means providing tension/length to the cables be mounted themselves in a moving fashion.

Movement of items can be performed between any two points within the warehouse, the items moved on their own or within transport means, e.g. totes, trays, cartons etc. The transport vehicle can function as a conveyor, lift or a combination of the two for transport of items between storage locations or non-storage locations, buffer positions, put walls etc. It is preferred that the movement in a given workspace along the face of a storage racking is by controlled movement of the at least four cable tensioning means along the face of the storage racking within the given workspace along guide tracks.

This also solves the increasing complexity of the control problem and of the growing cable reels. For example, if a cable guided system can operate optimally in a 50 m×12 m workspace, but the racking design requires the operation of a storage and retrieval machine (ASRS) platform in a 100 m×12 m workspace, then this invention proposes the entire cabled system be made moveable such that the movement ASRS platform spans the totality of only the optimal workspace. So, the extra 50 m width would be covered by moving a “virtual frame” of the cable driven storage and retrieval machine by 50 m in the required direction, by moving the cable tensioning means.

In a preferred embodiment, the cable tensioning means are made moveable in synchronized fashion meaning that they move in the required direction in unison by controlled/supervised movement along guide tracks. To do so it is possible to control the movement of each cable tensioning means alone. Alternatively, it is possible to mechanically couple two cable tensioning means together, e.g. by a vertically or horizontally orientated cross beam etc.

It is also possible that the upper two cable tensioning means are coupled together mechanically and the lower two cable tensioning means are coupled together mechanically, wherein one of the upper or lower cable tensioning means are actively moveable and the other of the upper or lower cable tensioning means are passively moveable upon movement of the active moveable means. In other words, at least two upper cable tensioning means are connected and at least two lower cable tensioning means are connected and one of the upper and one of the lower cable tensioning means is actively driven wherein the remaining one moves passively, i.e. tags along. Additionally, a complete frame using vertically and horizontally orientated beams could be used to connect at least four cable tensioning means together.

According to an aspect of the invention a larger workspace area is preferably divided into smaller workspaces in each of which a cable driven storage and retrieval machine can operate in an optimal manner. In other words, the workspace can be divided vertically and/or horizontally into sub-workspaces and each cable driven storage and retrieval machine would only operate in its specific sub-workspace.

The sub-workspaces can be variable or fixed. If the sub-workspaces are variable in size, meaning that the adjacent boundaries are moveable to enlarge one sub-workspace and at the same time shrink the adjacent sub-workspace, then some of the cable tensioning means may be fixed, namely those at the fixed boundaries, and some may be moveable, namely those moving with the moving/displaced boundary.

Especially preferred is the use in a warehouse with a storage arrangement with a storage racking and use of the cable driven storage and retrieval machine for storage and retrieval of items from the shelving of the storage racking, wherein the cable driven storage and retrieval machine can access a given workspace of the storage racking.

Further features and details of the invention are apparent from the description hereinafter of the drawings.

### BRIEF DESCRIPTION OF THE DRAWINGS

FIG. 1 shows a warehousing robot according to the prior art; and

FIGS. 2 through 9 show different embodiments according to the invention.

### DESCRIPTION OF THE PREFERRED EMBODIMENTS

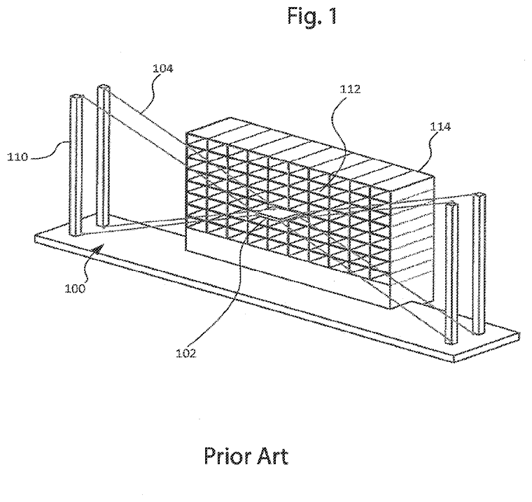

Turning to FIG. 1, a view of an apparatus for controlling movement of a platform according to the prior art is shown. The apparatus 100 is a warehousing robot. The warehousing robot 100 includes a platform 102 from which a set of cables 104 extends. At one end, or a first end, of each cable 104, the cable 104 is connected to the platform 102 and at the opposite, or second end, the cable 104 is connected to a motor for controlling length or tension in the cable 104. The warehousing robot 100 may further include an apparatus, or cable controlling mechanism, for receiving and/or collecting the cable that is controlled by the motor.

As schematically shown in FIG. 1, the apparatus 100 may further include a frame 110 which supports the platform 102 and the cables 104. Although not shown, the cable controlling mechanism and the motor may be mounted within or to the frame 110 in a stationary manner.

A user can control the apparatus 100 to obtain items from the shelves 112 of a storage racking 114, its face defining a workspace of the apparatus 100, located within a warehouse. The apparatus 100 may include a robot arm or the like, which may be mounted or connected to the platform 102, to reach into the shelves 112 to retrieve an item. After obtaining the item, the platform 102 is controlled to deliver the item to the user or a specific location. The delivery of the item will be understood by one skilled in the art.

In operation, when an item is requested, a signal is transmitted via a central processing unit to the apparatus identifying the location of the requested item. The platform is then moved via the set of cables and the motors (and the cable controlling mechanism) to the identified location whereby the item is then retrieved and placed on the platform. The apparatus (including the frame) may be placed between two shelving racks whereby one of these warehousing robots is used for one or both of the shelving racks. Cable systems for use in the control of the platform such that the platform does not move in undesired degrees of freedom and calculations performed to determine required motor movements is provided in US 2015/0217975 A1.

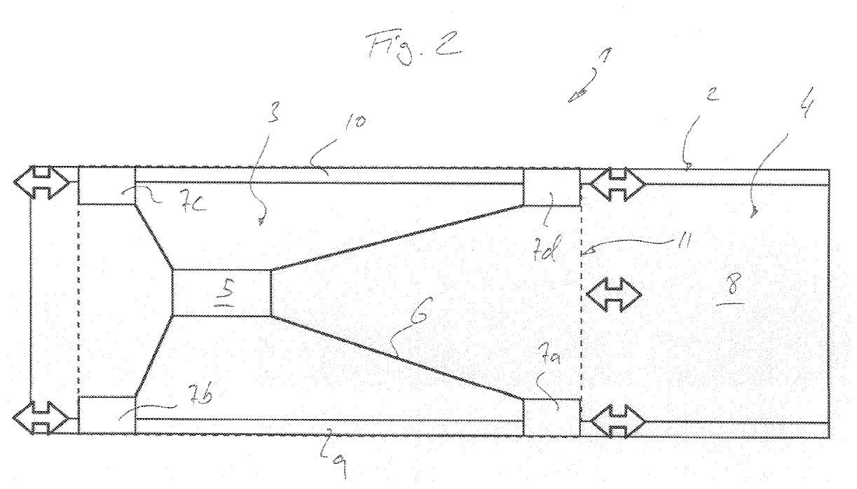

FIGS. 2-9 detail embodiments according to the claimed invention.

In all of the figures a storage arrangement 1 with a storage racking 2 and cable driven storage and retrieval machine 3 for storage and retrieval of items from the shelving 4 of the storage racking 2 in a warehouse is shown.

The cable driven storage and retrieval machine 3 comprises a load handling platform 5 being suspended by cables 6, which are variable in length and tension by cable tensioning means 7, such that the load handling platform can access a given workspace 8 of the storage racking.

The cable tensioning means 7 comprise a winch/drum and a drive motor and controls as known in the prior art.

According to the inventive concept, the cable tensioning means 7 are made to be moveable within the given workspace 8, and not fixed as known in the prior art.

In the embodiment of FIG. 2, the cable tensioning means 7a, b, c, d are arranged to be guided along a horizontal upper 10 and lower guide track 9.

Meaning that the two lower left and right cable tensioning means 7a, b are moveable along the guide track 9 and the two upper left and right cable tensioning means 7c, d are moveable along the upper guide track 10.

In other words, the cable driven storage and retrieval machine 3 can optimally operate within a sub-workspace 11 (hashed box), which in turn is displaced horizontally within the greater workspace 8 (face of the storage racking 2) to reach every position within the storage racking 2.

For this displacement the cable tensioning means 7a, b, c, d are moved along the guide tracks 9, 10 in a synchronized fashion such that the load handling platform 5 being suspended by cables 6 does not sag. In other words, control of all four tensioning means with respect to each other is performed.

As stated the guide tracks do not need to be arranged along the storage racking but could also be placed differently with the warehouse to perform displacement of the cable tensioning means 7a, b, c, d and in this way of the given workspace between other known warehouse function areas.

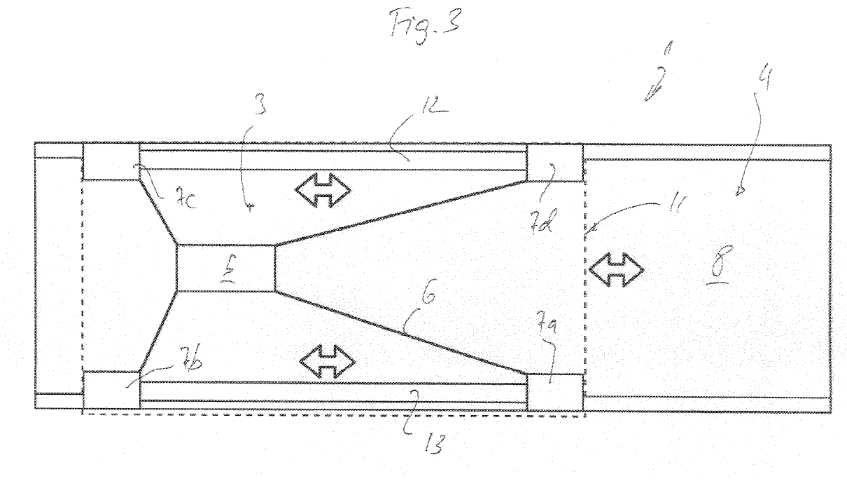

In contrast, the embodiments of FIGS. 3-5 have mechanically coupled tensioning means 7, so that the horizontal and/or vertical distance between at least two of them is fixed, i.e. they are forced to move together/in unison, lowering the necessary degree of control.

In FIG. 3, the upper two tensioning means 7c, d are linked by a horizontal cross beam 12 and the two lower tensioning means 7a, b are linked by a horizontal cross beam 13. Therefore, only movement of the upper cable tensioning means 7c, d along the guide tracks must be controlled with respect to the lower cable tensioning means 7a, b.

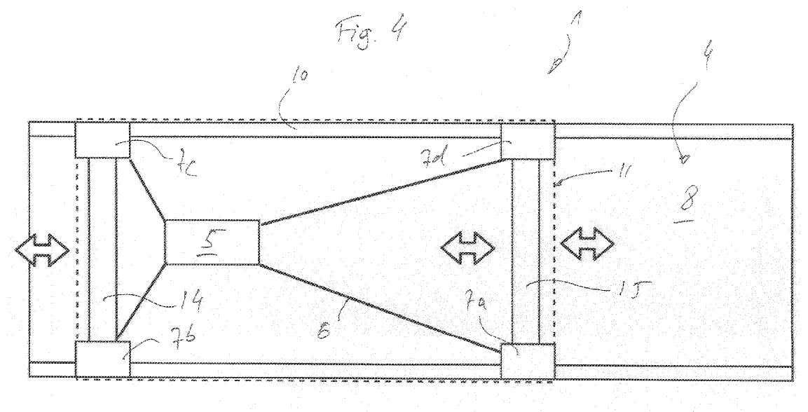

In FIG. 4, the left-hand two tensioning means 7b, c are linked by a vertical cross beam 14 and the two right-hand tensioning means 7a, d are linked by a vertical cross beam 15. Therefore, only movement of the left-hand cable tensioning means 7b, c along the guide tracks must be controlled with respect to the right-hand cable tensioning means 7a, d.

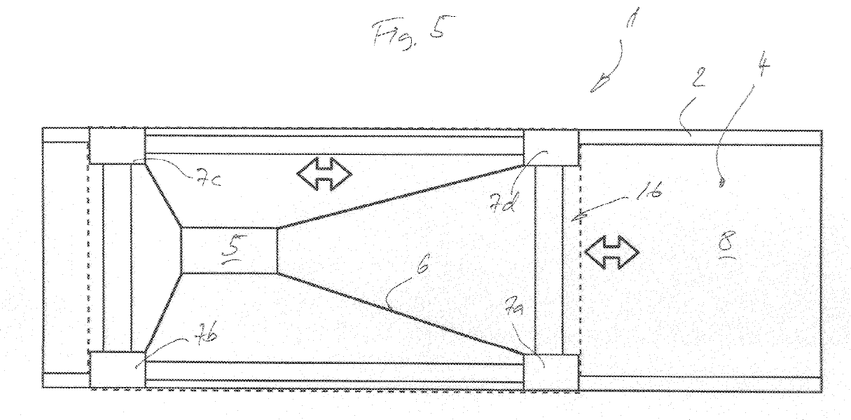

In FIG. 5 a complete frame 16 using vertically and horizontally orientated beams 12-15 is used to connect all four cable tensioning means 7a, b, c, d together, such that their position with respect to each other is fixed. Therefore, only movement of whole frame 16 defining the sub-workspace 11 must be controlled with respect to the full workspace 8 of the complete storage racking 2 face.

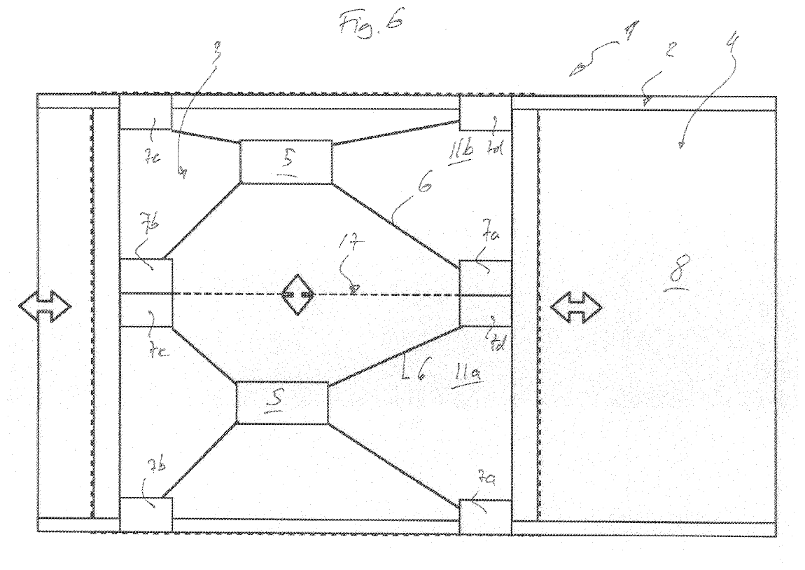

According to the embodiments of FIGS. 6-9, the workspace 8 of the storage racking 2 is divided into at least two sub-workspaces 11a, b, each having its own cable driven storage and retrieval machine 3a, b.

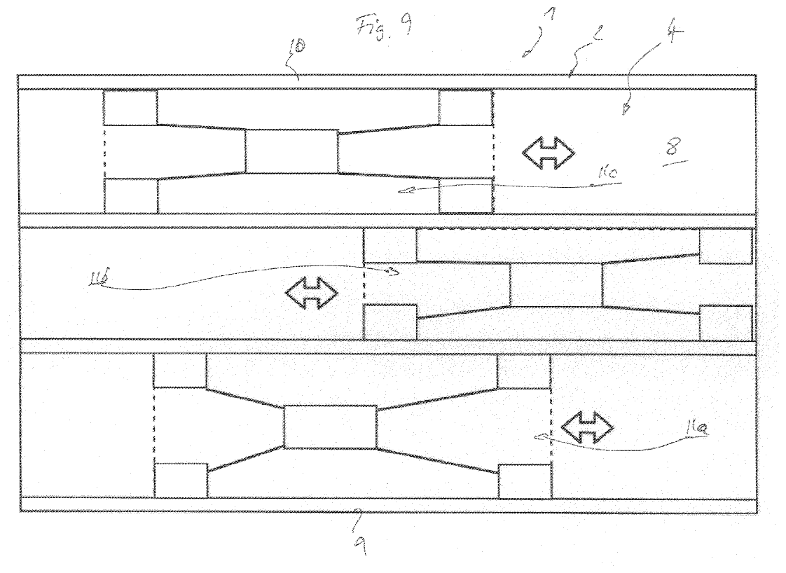

In principle the sub-workspaces may be fixed in size, as in FIG. 9, wherein the full workspace 8 is vertically divided into three horizontally extending sub-workspaces 11a, b, c, which each have an own cable driven storage and retrieval machine 3, according to FIG. 2.

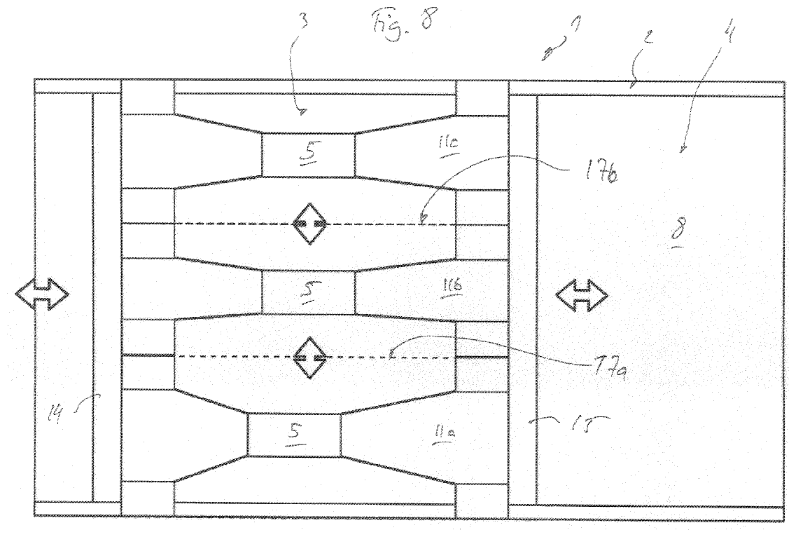

In contrast, the embodiments of FIGS. 6-8 encompass variable sub-workspaces 11a, b (or 11c in FIG. 8) that have a mutual boundary 17 between them, that is vertically moveable.

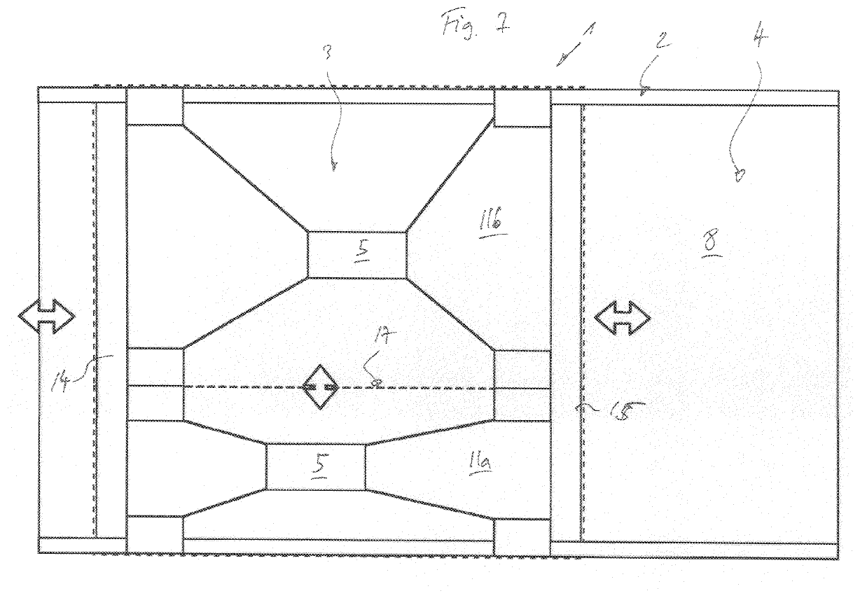

In FIGS. 6 and 7 the workspace 8 is vertically divided into two horizontally extending sub-workspaces 11a, b, having a mutual boundary 17, whereas in FIG. 8 the division is threefold into three sub-workspaces 11a, b, c having a mutual boundary 17a between sub-workspaces 11a and 11b and a respective mutual boundary 17b between sub-workspaces 11b and 11c.

In contrast to FIG. 9, all cable driven storage and retrieval machines 3 in each sub-workspace 8 are linked left and right by vertically extending cross beams, in analogy to FIG. 4.

Therefore, the cable tensioning means are fixed, namely those at the fixed boundaries/guide tracks 9, 10, and some are moveable, namely those moving with the moving/displaced boundary or only being fixed with respect to the vertical cross beam 14, 15.

So in FIG. 8, movement the sub-workspaces 11 in horizontal direction along the guide tracks 9, 10 is performed by control of the cross beam 14, 15 movement and movement in vertical direction is controlled by displacement of the cable tensioning means at the boundary(s) 17.

Understandably, the shown cable driven transport vehicle can be used in other surroundings, for example between any two points within the warehouse and can function as a conveyor, lift or a combination of the two, for transport of items between storage locations or non-storage locations, buffer positions, etc. for movement of items on their own or within transport means, e.g. totes, trays, cartons etc.

1.-9. (canceled)

10. A warehouse with a cable driven storage and retrieval machine for movement of items within the warehouse, wherein the cable driven storage and retrieval machine comprises a load handling platform suspended by cables such that the load handling platform can access a given workspace of the warehouse, wherein the cables are variable in length and tensioned by cable tensioners, wherein the cable tensioners are moveable within the given workspace, and wherein the cable driven storage and retrieval machine comprises at least four cable tensioners that are moveable and individually operable in a synchronized fashion by a control to:
a) move the load handling platform in the given workspace along a face of a storage racking by controlled movement of the at least four cable tensioners along the face of the storage racking within the given workspace along guide tracks; and/or
b) operate the at least four cable tensioners in a controlled fashion to move the load handling platform in the given workspace along a face of a storage racking by controlled variation in length and tension of the cables.

11. The warehouse according to claim 10, wherein the given workspace is a sub-workspace of a whole workspace.

12. The warehouse according to claim 11, wherein the whole workspace is the complete face of the storage racking.

13. The warehouse according to claim 10, wherein two cable tensioners are coupled together mechanically by vertically or horizontally orientated beams or brackets.

14. The warehouse according to claim 13, wherein the cable driven storage and retrieval machine comprises four cable tensioners, and wherein an upper two cable tensioners are coupled together mechanically and a lower two cable tensioners are coupled together mechanically, wherein at least one of the upper cable tensioners and at least one of the lower cable tensioners are actively moveable and the other of the upper cable tensioners and lower cable tensioners are passively moveable upon movement of the active moveable cable tensioners.

15. The warehouse according to claim 13, wherein the given workspace is vertically and/or horizontally divided into smaller sub-workspaces within each of which a separate cable driven storage and retrieval machine is operative.

16. The warehouse according to claim 15, wherein the sub-workspaces are variable or fixed in size.

17. The warehouse according to claim 15, wherein the variable sub-workspaces have adjacent boundaries that are moveable to enlarge one sub-workspace and at the same time shrink an adjacent sub-workspace, and wherein some of the cable tensioners of each cable driven storage and retrieval machine are fixed and some are moveable.

18. The warehouse according to claim 17, wherein the fixed cable tensioners of each cable driven storage and retrieval machine are disposed at fixed boundaries, and wherein the moveable cable tensioners of each cable driven storage and retrieval machine move with moving displaceable boundaries.

19. The warehouse according to claim 10, wherein all the cable tensioners are connected together via a complete frame using vertically and horizontally orientated beams.

20. The warehouse according to claim 19, wherein the given workspace is vertically and/or horizontally divided into smaller sub-workspaces within each of which a separate cable driven storage and retrieval machine is operative.

21. The warehouse according to claim 20, wherein the sub-workspaces can be variable or fixed in size.

22. The warehouse according to claim 20, wherein the variable sub-workspaces have adjacent boundaries that are moveable to enlarge one sub-workspace and at the same time shrink an adjacent sub-workspace, and wherein some of the cable tensioners of each cable driven storage and retrieval machine are fixed and some may are moveable.

23. The warehouse according to claim 22, wherein the fixed cable tensioners of each cable driven storage and retrieval machine are disposed at fixed boundaries, and wherein the moveable cable tensioners of each cable driven storage and retrieval machine move with moving displaceable boundaries.

24. The warehouse according to claim 10, wherein the given workspace is vertically and/or horizontally divided into smaller sub-workspaces within each of which a separate cable driven storage and retrieval machine is operative.

25. The warehouse according to claim 24, wherein the sub-workspaces can be variable or fixed in size.

26. The warehouse according to claim 24, wherein the variable sub-workspaces have adjacent boundaries that are moveable to enlarge one sub-workspace and at the same time shrink an adjacent sub-workspace, and wherein some of the cable tensioners of each cable driven storage and retrieval machine are fixed and some are moveable.

27. The warehouse according to claim 26, wherein the fixed cable tensioners of each cable driven storage and retrieval machine are disposed at fixed boundaries, and wherein the moveable cable tensioners of each cable driven storage and retrieval machine move with moving displaceable boundaries.

28. A warehouse with a cable driven storage and retrieval machine for movement of items within the warehouse, wherein the cable driven storage and retrieval machine comprises a load handling platform suspended by cables such that the load handling platform can access a given workspace of the warehouse, wherein the cables are variable in length and tensioned by cable tensioners, wherein the cable tensioners are moveable within the given workspace, and wherein the cable driven storage and retrieval machine comprises at least four cable tensioners that are moveable and individually operable in a synchronized fashion by a control to:
a) move the load handling platform in the given workspace along a face of a storage racking by controlled movement of the at least four cable tensioners along the face of the storage racking within the given workspace along guide tracks; and/or
b) operate the at least four cable tensioners in a controlled fashion to move the load handling platform in the given workspace along a face of a storage racking by controlled variation in length and tension of the cables; and
wherein the given workspace is a sub-workspace of a whole workspace, and wherein two cable tensioners are coupled together mechanically by vertically or horizontally orientated beams or brackets.

29. The warehouse according to claim 28, wherein the whole workspace is the complete face of the storage racking.
